(19) United States
(12) Patent Application Publication
(10) Pub. No.: US 2026/0259434 A1
(43) Pub. Date: Sep. 3, 2026

(54) WAVEFRONT SENSOR AND ADAPTIVE OPTICS APPARATUS

(71) Applicant: Osaka Research Institute of Industrial Science and Technology, Osaka (JP)

(72) Inventor: Yohei NISHIZAKI, Osaka (JP)

(73) Assignee: Osaka Research Institute of Industrial Science and Technology, Osaka (JP)

(21) Appl. No.: 19/451,121

(22) Filed: Jan. 16, 2026

(30) Foreign Application Priority Data
Feb. 28, 2025 (JP) 2025-031585

(51) Int. Cl. G02F 1/01; G01J 1/04; G01J 1/44

(52) U.S. Cl. CPC G02F 1/0121; G01J 1/0411; G01J 1/44

(57) ABSTRACT

A wavefront sensor includes a line-focusing element, a line sensor, and a wavefront aberration estimator. The line-focusing element focuses, in a line, light travelled through a medium. The line sensor receives the light focused in a line to obtain a one-dimensional image of the light. A wavefront aberration parameter estimation unit included in the wavefront aberration estimator inputs a pre-processed image of the one-dimensional image to a wavefront aberration parameter estimation model trained by machine learning and causes the wavefront aberration parameter estimation model to output a wavefront aberration parameter representing a wavefront aberration due to the medium.

### CROSS REFERENCE TO RELATED APPLICATIONS

This nonprovisional application is based on Japanese Patent Application No. 2025-031585 filed on February 28, 2025, with the Japan Patent Office, the entire content of which is hereby incorporated by reference.

### BACKGROUND OF THE INVENTION

### Field of The Invention

The present disclosure relates to a wavefront sensor and an adaptive optics apparatus.

### Description of the Background Art

Yohei Nishizaki et.al., "Deep learning wavefront sensing," Optics Express, January 7, 2019, Vol.27, No.1, p. 240-251 discloses wavefront sensing using deep learning.

### SUMMARY OF THE INVENTION

An object according to a first aspect of the present disclosure is to provide a wavefront sensor which can perform faster sensing of wavefront aberration due to a medium. An object according to a second aspect of the present disclosure is to provide an adaptive optics apparatus that can compensate, at a higher speed, for wavefront aberration due to a medium.

The wavefront sensor according to the present disclosure includes a line-focusing element, a line sensor, and a wavefront aberration estimator. The line-focusing element focuses, in a line, light traveled through a medium. The line sensor receives the light focused in a line by the line-focusing element to obtain a one-dimensional image of the light. The wavefront aberration estimator includes an image pre-processing unit and a wavefront aberration parameter estimation unit. The image pre-processing unit pre-processes the one-dimensional image to generate a pre-processed image. The wavefront aberration parameter estimation unit inputs the pre- processed image to a wavefront aberration parameter estimation model, trained by machine learning, to cause the wavefront aberration parameter estimation model to output wavefront aberration parameters representing wavefront aberration due to the medium.

The adaptive optics apparatus according to the present disclosure includes the wavefront sensor according to the present disclosure, a spatial light modulator, and a controller. The controller is communicatively connected to the spatial light modulator and the wavefront sensor, and can control the spatial light modulator. The controller receives the wavefront aberration due to the medium from the wavefront sensor and causes the spatial light modulator to form a two-dimensional phase distribution. A compensating wavefront aberration due to the two-dimensional phase distribution cancels the wavefront aberration due to the medium.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view of a wavefront sensor according to Embodiment 1.

FIG. 2 is a diagram showing a hardware configuration of a wavefront aberration estimator according to Embodiment 1.

FIG. 3 is a block diagram illustrating a functional configuration of the wavefront aberration estimator according to Embodiment 1.

FIG. 4A is a diagram illustrating one example of pixel rearrangement.

FIG. 4B is a diagram illustrating another example of the pixel rearrangement.

FIG. 5 is a diagram showing a flowchart for a method of wavefront aberration sensing according to Embodiments 1 and 2.

FIG. 6 is a diagram showing a flowchart for a step of estimation of the wavefront aberration according to Embodiments 1 and 2.

FIG. 7A is a diagram showing an example of a one-dimensional image that is output from a line sensor included in the wavefront aberration estimator.

FIG. 7B is a diagram showing a graph of a wavefront aberration parameter that is obtained by the wavefront aberration estimator.

FIG. 7C is a diagram showing an example of a phase map of the wavefront aberration due to a medium.

FIG. 8 is a diagram showing a flowchart for a method of generation of a wavefront aberration parameter estimation model according to Embodiments 1 and 2.

FIG. 9 is a schematic view of a training-dataset generation device according to Embodiment 1.

FIG. 10 is a diagram showing a hardware configuration of a training-data generator according to Embodiments 1 and 2.

FIG. 11 is a diagram showing a flowchart for a method of generation of a training dataset according to Embodiments 1 and 2.

FIG. 12A is a diagram showing an example of a wavefront aberration parameter that is generated by the training-data generator.

FIG. 12B is a diagram showing an example of a two-dimensional phase distribution formed on a spatial light modulator included in the training-dataset generation device.

FIG. 12C is a diagram showing an example of a one-dimensional image obtained by a line sensor included in the training-dataset generation device.

FIG. 13 is a diagram showing a hardware configuration of a wavefront aberration parameter estimation model generation device according to Embodiments 1 and 2.

FIG. 14 is a block diagram illustrating a functional configuration of the wavefront aberration parameter estimation model generation device according to Embodiments 1 and 2.

FIG. 15 is a block diagram for illustrating a process by a machine learning unit (a machine learning feature) according to Embodiments 1 and 2.

FIG. 16 is a diagram showing a flowchart for a step of training the wavefront aberration parameter estimation model according to Embodiments 1 and 2 by machine learning.

FIG. 17 is a schematic view of an adaptive optics apparatus according to Embodiments 1 and 2.

FIG. 18 is a schematic view of a wavefront sensor according to Embodiment 2.

FIG. 19 is a schematic view of a training-dataset generation device according to Embodiment 2.

### DESCRIPTION OF THE PREFERRED EMBODIMENTS

Hereinafter, embodiments according to the present disclosure will be described. Note that like reference number refers to like configurations, and description thereof will not be repeated.

### Embodiment 1

### Wavefront Sensor 1

Referring to FIG. 1, a wavefront sensor 1 according to Embodiment 1 is now described. Wavefront sensor 1 can perform sensing of a wavefront aberration due to a medium 6. Wavefront sensor 1 is applicable to, for example, a receiver device of an optical satellite communications device. If wavefront sensor 1 is applied to a receiver device of an optical satellite communications device, wavefront sensor 1 is mounted on the surface of the Earth, for example. Wavefront sensor 1 includes a line-focusing element 15, a line sensor 16, and a wavefront aberration estimator 20. Wavefront sensor 1 may further include a two-dimensional focusing element 10 and a mask 11.

Referring to FIG. 1, a light source 3 emits light 4. If wavefront sensor 1 is applied to a receiver device of an optical satellite communications device, light source 3 is, for example, included in a transmitter device of the optical satellite communications device and mounted on a satellite. Light source 3 is, for example, a laser light source or a superluminescent diode (SLD).

Light 4 travels through medium 6. If wavefront sensor 1 is applied to a receiver device of an optical satellite communications device, medium 6 is the atmosphere of the Earth. Upon receiving an aberration of medium 6, light 4 turns to light 7 that has a disturbed wavefront. The wavefront aberration due to medium 6, which is sensed by wavefront sensor 1, is a difference between a wavefront of light 4 and a wavefront of light 7. Light 4 and 7, as used herein, are not limited to light such as infrared light, visible light, and ultraviolet light, but includes millimeter waves, radio waves, and X-ray.

On an optical path 8 of light 7, two-dimensional focusing element 10 is disposed on the light 7 incident side of mask 11, line-focusing element 15, and line sensor 16. Light 7 is incident on two-dimensional focusing element 10. Two-dimensional focusing element 10 isotropically focuses light 7 in a plane orthogonal to optical path 8 of light 7. Two-dimensional focusing element 10 may be, but not particularly limited to, a spherical lens such as a plano convex lens or a bioconvex lens, or at least one curved mirror.

Mask 11 is disposed between two-dimensional focusing element 10 and line-focusing element 15 on optical path 8 of light 7. Mask 11 is disposed on the rear focal plane of two-dimensional focusing element 10 and on the front focal plane of line-focusing element 15. Mask 11 includes: a central light-shielding region 12; a peripheral light-shielding region 13; and an annular opening 14 formed between central light-shielding region 12 and peripheral light-shielding region 13. Light 7 passes through annular opening 14. Annular opening 14 has a diameter of 1 mm, for example. Central light-shielding region 12 blocks an image of light source 3, enabling line sensor 16 to accurately detect light 7. Central light-shielding region 12 has a diameter of 100 μm, for example.

Line-focusing element 15 is disposed between mask 11 and line sensor 16 on optical path 8 of light 7. Line-focusing element 15 is an optical element whose focusing power in a direction orthogonal to the arrangement direction of the pixels of line sensor 16 in a plane orthogonal to optical path 8 of light 7 is greater than the focusing power of the arrangement direction of the pixels of line sensor 16, and focuses light 7 primary in the direction orthogonal to the arrangement direction of the pixels of line sensor 16. In this manner, line-focusing element 15 focuses light 7 in a line. Line-focusing element 15 may be, for example, a line-focusing lens such as a cylindrical lens, or at least one curved mirror.

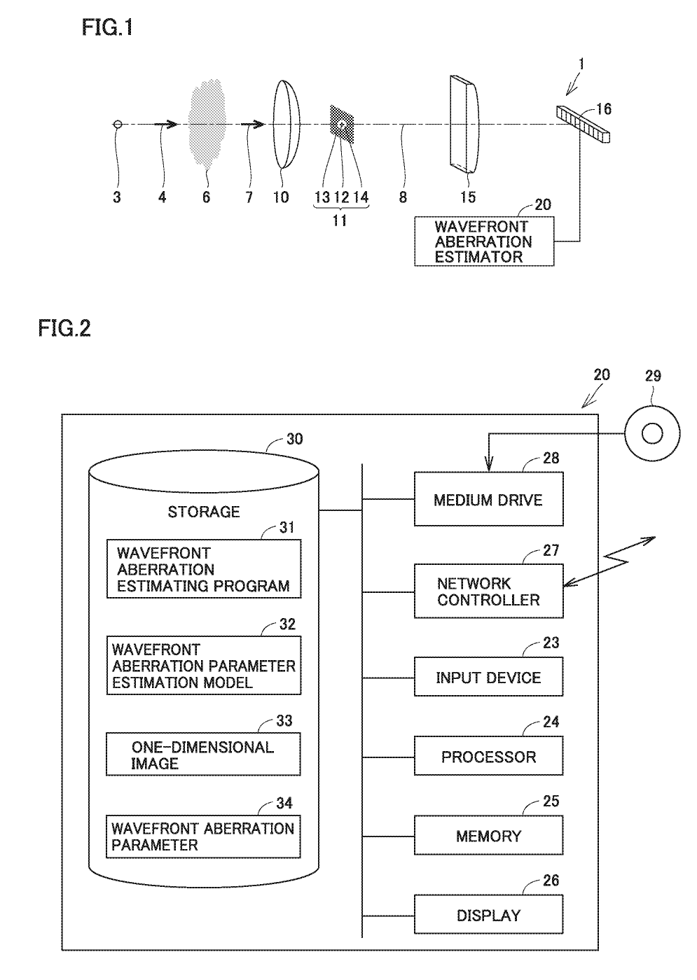

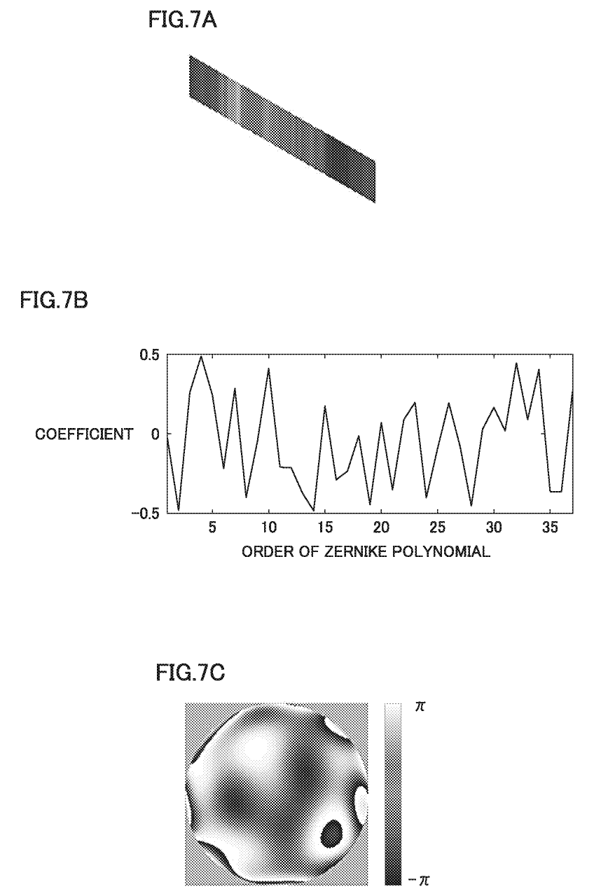

Line sensor 16 is disposed on the rear focal plane of line-focusing element 15. Line sensor 16 includes one-dimensionally arranged pixels. The pixels each include a CMOS (Complementary Metal Oxide Semiconductor) sensor, for example. Line sensor 16 receives light 7, focused in a line by line-focusing element 15, to obtain a one-dimensional image 33 (see FIGS. 2 and 7A) of light 7. One-dimensional image 33 of light 7 represents a one-dimensional intensity distribution of light 7 on line sensor 16. Line sensor 16 outputs one-dimensional image 33 to wavefront aberration estimator 20.

Line sensor 16 has a frame rate of 10 kHz or higher, for example. Line sensor 16 may have a frame rate of 50 kHz or higher or 100 kHz or higher. The frame rate of line sensor 16 indicates the number of one-dimensional images 33 that can be output from line sensor 16 per second. For example, a "Xposure Camera" manufactured by Austrian Institute of Technology having a frame rate of 600 kHz, or a "H2-HM-16k100H-00B" manufactured by Teledyne Technologies having a frame rate of 1 MHz can be used as line sensor 16.

Wavefront aberration estimator 20 receives one-dimensional image 33 of light 7 from line sensor 16. Wavefront aberration estimator 20 outputs a wavefront aberration parameter 34 (see FIG. 2) from one-dimensional image 33. Wavefront aberration parameter 34 is a parameter representing the wavefront aberration due to medium 6. The wavefront aberration can be represented by a Zernike polynomial, for example. Referring to FIG. 7B, wavefront aberration parameter 34 is a set of coefficients of a Zernike polynomial, for example. In this manner, wavefront aberration estimator 20 estimates the wavefront aberration due to medium 6 from one-dimensional image 33. Wavefront aberration estimator 20 may further generate a phase map of the wavefront aberration due to medium 6 (see FIG. 7C) from wavefront aberration parameter 34.

### Hardware Configuration

Referring to FIG. 2, a hardware configuration of wavefront aberration estimator 20 is now described. Wavefront aberration estimator 20 includes an input device 23, a processor 24, a memory 25, a display 26, a network controller 27, a medium drive 28, and a storage 30.

Input device 23 receives various input operations. For example, input device 23 is a keyboard, a mouse, or a touch panel.

Display 26 shows wavefront aberration parameter 34 (see FIG. 7B) or a phase map of the wavefront aberration due to medium 6 generated from wavefront aberration parameter 34 (see FIG. 7C). Display 26 is an LCD (Liquid Crystal Display) or an organic EL (Electroluminescence) display, for example. Display 26 receives and shows wavefront aberration parameter 34 or the phase map of the wavefront aberration due to medium 6.

Processor 24 executes a wavefront aberration estimating program 31, thereby performing processes that are required to implement the functions of wavefront aberration estimator 20. Processor 24 is configured of, for example, a central processing unit (CPU) or a graphics processing unit (GPU).

In processor 24 executing wavefront aberration estimating program 31, etc., memory 25 provides a storage area for temporarily storing program codes or a work memory, for example. For example, memory 25 is a volatile memory device such as a dynamic random access memory (DRAM) or a static random access memory (SRAM).

Network controller 27 transmits/receives programs or data to/from any device through a communication network (not shown) such as the Internet or the Intranet. For example, network controller 27 transmits wavefront aberration parameter 34 or the phase map of the wavefront aberration due to medium 6 to a computer (not shown) external to wavefront aberration estimator 20, a display (not shown), or a memory device (not shown) through the communication network. Network controller 27 receives a wavefront aberration parameter estimation model 32 from a wavefront aberration parameter estimation model generation device 60 (see FIG. 13) through the communication network. Network controller 27 supports any communication scheme such as Ethernet (registered trademark), a wireless LAN (Local Area Network), or Bluetooth (registered trademark).

Medium drive 28 is a device for reading programs or data that are stored in a computer-readable medium 29. Medium drive 28 may further be a device for writing programs or data into computer-readable medium 29. Computer-readable medium 29 is a non-transitory storage medium, storing programs or data in a non-volatile manner. For example, computer-readable medium 29 is an optical storage medium such as an optical disk (e.g., CD-ROM or DVD-ROM), a semiconductor storage medium such as a flash memory or a USB (Universal Serial Bus) memory, a magnetic storage medium such as a hard disk, a flexible disk (FD), or a storage tape, or a magneto-optical storage media such as a magneto-optical (MO) disk.

Storage 30 stores wavefront aberration estimating program 31, wavefront aberration parameter estimation model 32, one-dimensional image 33 of light 7, wavefront aberration parameter 34, etc. Wavefront aberration parameter estimation model 32 is a model that is trained by machine learning, as described below. Wavefront aberration estimating program 31 is a program for obtaining wavefront aberration parameter 34 from one-dimensional image 33. A pre-processed image 33b of one-dimensional image 33 is input to wavefront aberration parameter estimation model 32, which then outputs wavefront aberration parameter 34. For example, storage 30 is a nonvolatile memory device such as a hard disk or a solid state drive (SSD).

Programs for implementing the functions of wavefront aberration estimator 20 may be distributed in the form of a non-transitory computer-readable medium 29 and installed in storage 30. The programs for implementing the functions of wavefront aberration estimator 20 may be download to wavefront aberration estimator 20 through a communication network such as the Internet or the Intranet. The programs for implementing the functions of wavefront aberration estimator 20 include wavefront aberration estimating program 31 (see FIG. 2).

In the present embodiment, the functions of wavefront aberration estimator 20 are implemented by a general purpose computer (processor 24) executing programs,

including wavefront aberration estimating program 31. However, the present disclosure is not limited thereto. All or some of the functions of wavefront aberration estimator 20 may be implemented using an integrated circuit such as an application specific integrated circuit (ASIC) or a field-programmable gate array (FPGA).

### Functional Configuration

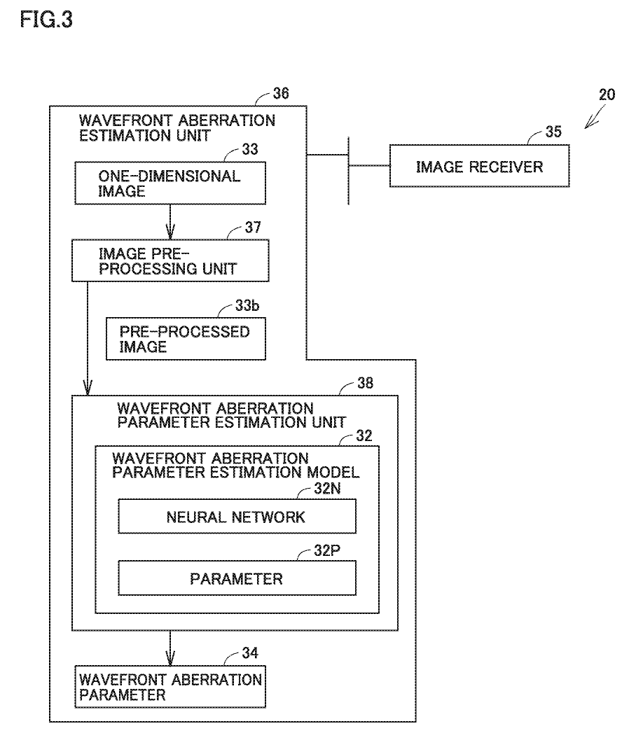

Referring to FIG. 3, an example of a functional configuration of wavefront aberration estimator 20 is now described. Wavefront aberration estimator 20 includes an image receiver 35 and a wavefront aberration estimation unit 36.

Image receiver 35 receives one-dimensional image 33 of light 7 (see FIGS. 2 and 7A) from line sensor 16. Image receiver 35 outputs one-dimensional image 33 to storage 30. Storage 30 stores one-dimensional image 33. Image receiver 35 is implemented by network controller 27 (see FIG. 2), for example.

Wavefront aberration estimation unit 36 receives one-dimensional image 33 of light 7 and outputs wavefront aberration parameter 34 (see FIG. 7B). In this manner, wavefront aberration estimation unit 36 estimates the wavefront aberration due to medium 6 from one-dimensional image 33. Wavefront aberration estimation unit 36 is a function of wavefront aberration estimator 20 that is implemented by processor 24 (see FIG. 2) executing wavefront aberration estimating program 31. Wavefront aberration estimation unit 36 includes an image pre-processing unit 37 and a wavefront aberration parameter estimation unit 38.

Image pre-processing unit 37 pre-processes one-dimensional image 33 of light 7 to generate pre-processed image 33b. For example, image pre-processing unit 37 applies pre-processes such as correcting white balance, correcting contrast, resizing, normalization, de-noising, or filtering to one-dimensional image 33. Image pre-processing unit 37 outputs pre-processed image 33b to wavefront aberration parameter estimation unit 38.

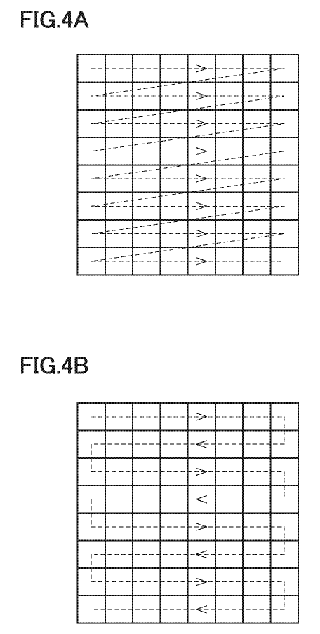

If wavefront aberration parameter estimation model 32 includes a convolutional neural network (CNN), image pre-processing unit 37 may convert one-dimensional image 33 into a two-dimensional image and generate the two-dimensional image as pre-processed image 33b. For example, image pre-processing unit 37 converts one-dimensional image 33 into a two-dimensional image by two-dimensionally rearranging (reshaping) the pixels of one-dimensional image 33. FIGS. 4A and 4B show an example of the method of reshaping. The pixels of one-dimensional image 33 are rearranged as illustrated by the dotted arrows in FIGS. 4A and 4B to convert one-dimensional image 33 into a two-dimensional image.

Wavefront aberration parameter estimation unit 38 outputs wavefront aberration parameter 34 (see FIG. 7B) from pre-processed image 33b generated by image pre-processing unit 37. Wavefront aberration parameter estimation unit 38 includes wavefront aberration parameter estimation model 32. Wavefront aberration parameter estimation model 32 includes a neural network 32N and a parameter 32P. Neural network 32N is a neural network categorized as a deep neural network (DNN). Neural network 32N may include a convolutional neural network (CNN).

Specifically, wavefront aberration parameter estimation unit 38 receives pre-processed image 33b from image pre-processing unit 37. Wavefront aberration parameter estimation unit 38 inputs pre-processed image 33b to wavefront aberration parameter estimation model 32 and causes wavefront aberration parameter estimation model 32 to output wavefront aberration parameter 34 corresponding to one-dimensional image 33. Wavefront aberration parameter estimation unit 38 may generate the phase map of the wavefront aberration due to medium 6 (see FIG. 7C) from wavefront aberration parameter 34 and output the phase map of the wavefront aberration due to medium 6. Wavefront aberration estimation unit 36 outputs wavefront aberration parameter 34 or the phase map of the wavefront aberration due to medium 6 to at least one of display 26 (see FIG. 2) or storage 30 (see FIG. 2), for example.

### Method of Sensing Wavefront Aberration Due to Medium 6

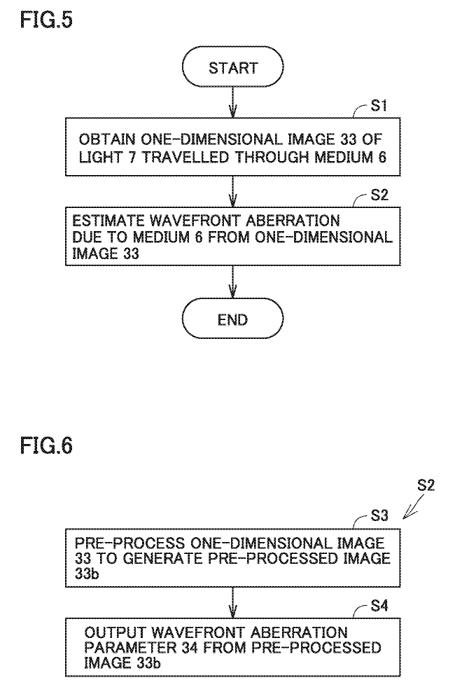

Referring to FIGS. 5 and 6, the method of sensing the wavefront aberration due to medium 6, using wavefront sensor 1 according to the present embodiment, is now described. The method of sensing the wavefront aberration according to the present embodiment includes obtaining one-dimensional image 33 of light 7 travelled through medium 6 (step S1); and estimating the wavefront aberration due to medium 6 from one-dimensional image 33 (step S2).

Referring to FIGS. 1 and 2, step S1 (see FIG. 5) is now described.

If wavefront sensor 1 is applied to a receiver device of an optical satellite communications device, light source 3 is, for example, mounted on a satellite, residing sufficiently remote from the surface of the Earth on which the wavefront sensor 1 is mounted. Therefore, light 4 emitted from light source 3 reaches medium 6, as a plane wave. Upon receiving the aberration of medium 6, light 4 turns to light 7 that has a disturbed wavefront. The wavefront aberration due to medium 6, sensed by the method according to the present embodiment, is a difference between the wavefront of light 4 and the wavefront of light 7.

Two-dimensional focusing element 10 isotropically focuses light 7 in a plane orthogonal to optical path 8 of light 7. Mask 11 is disposed on the rear focal plane of two-dimensional focusing element 10 and on the front focal plane of line-focusing element 15. Central light-shielding region 12 of mask 11 blocks an image of light source 3. Light 7 passes through annular opening 14 in mask 11. Line-focusing element 15 focuses light 7 in a line on line sensor 16. Line sensor 16 receives light 7 focused in a line by line-focusing element 15. Line sensor 16 obtains one-dimensional image 33 of light 7 (see FIGS. 2 and 7A). Line sensor 16 outputs one-dimensional image 33 to wavefront aberration estimator 20. Image receiver 35 (see FIG. 3) receives one-dimensional image 33 from line sensor 16 and outputs it to storage 30. Storage 30 stores one-dimensional image 33.

Step S2 (see FIGS. 5 and 6) is now described.

Wavefront aberration estimation unit 36 reads one-dimensional image 33 from storage 30. Wavefront aberration estimation unit 36 estimates the wavefront aberration due to medium 6 from one-dimensional image 33.

Specifically, image pre-processing unit 37 pre-processes one-dimensional image 33 to generate pre-processed image 33b (step S3). For example, image pre- processing unit 37 applies pre-processes such as correcting white balance, correcting contrast, resizing, normalization, de-noising, or filtering to one-dimensional image 33. Image pre-processing unit 37 outputs pre-processed image 33b to wavefront aberration parameter estimation unit 38. If wavefront aberration parameter estimation model 32 includes a convolutional neural network (CNN), image pre-processing unit 37 may convert one-dimensional image 33 into a two-dimensional image and generate the two-dimensional image as pre-processed image 33b. For example, image pre-processing unit 37 converts one-dimensional image 33 into a two-dimensional image by two-dimensionally rearranging (reshaping) the pixels of one-dimensional image 33.

Wavefront aberration parameter estimation unit 38 outputs wavefront aberration parameter 34 corresponding to one-dimensional image 33 (see FIG. 7B) from pre-processed image 33b generated by image pre-processing unit 37 (step S4). Specifically, wavefront aberration parameter estimation unit 38 receives pre-processed image 33b from image pre-processing unit 37. Wavefront aberration parameter estimation unit 38 inputs pre-processed image 33b to wavefront aberration parameter estimation model 32 and causes wavefront aberration parameter estimation model 32 to output wavefront aberration parameter 34 corresponding to one-dimensional image 33. Wavefront aberration parameter estimation unit 38 may generate the phase map of the wavefront aberration due to medium 6 (see FIG. 7C) from wavefront aberration parameter 34 and outputs the phase map of the wavefront aberration due to medium 6.

Wavefront aberration estimation unit 36 outputs wavefront aberration parameter 34 (see FIG. 7B) or the phase map of the wavefront aberration due to medium 6 (see FIG. 7C) to at least one of display 26 (see FIG. 2) or storage 30 (see FIG. 2), for example. Display 26 receives and shows wavefront aberration parameter 34 or the phase map of the wavefront aberration due to medium 6. Storage 30 stores wavefront aberration parameter 34 or the phase map of the wavefront aberration due to medium 6.

Wavefront aberration estimating program 31 causes processor 24 to perform the method of sensing the wavefront aberration due to medium 6 according to the present embodiment. Non-transitory computer-readable medium 29 according to the present embodiment may store wavefront aberration estimating program 31.

### Method of Generation of Wavefront Aberration Parameter Estimation Model 32

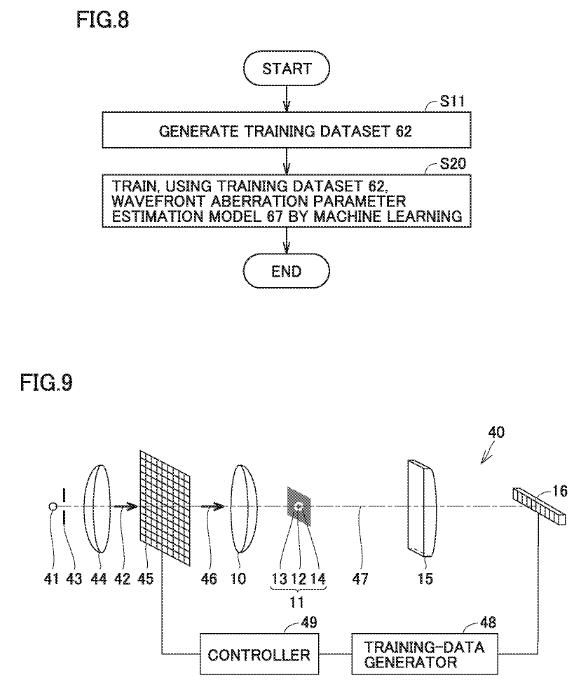

Referring to FIGS. 8 to 16, a method of generation of wavefront aberration parameter estimation model 32 according to the present embodiment is now described. Referring to FIG. 8, the method of generation of wavefront aberration parameter estimation model 32 according to the present embodiment includes generating a training dataset 62 (step S11); and training, using training dataset 62, a wavefront aberration parameter estimation model 67 by machine learning (step S20).

### Step S11

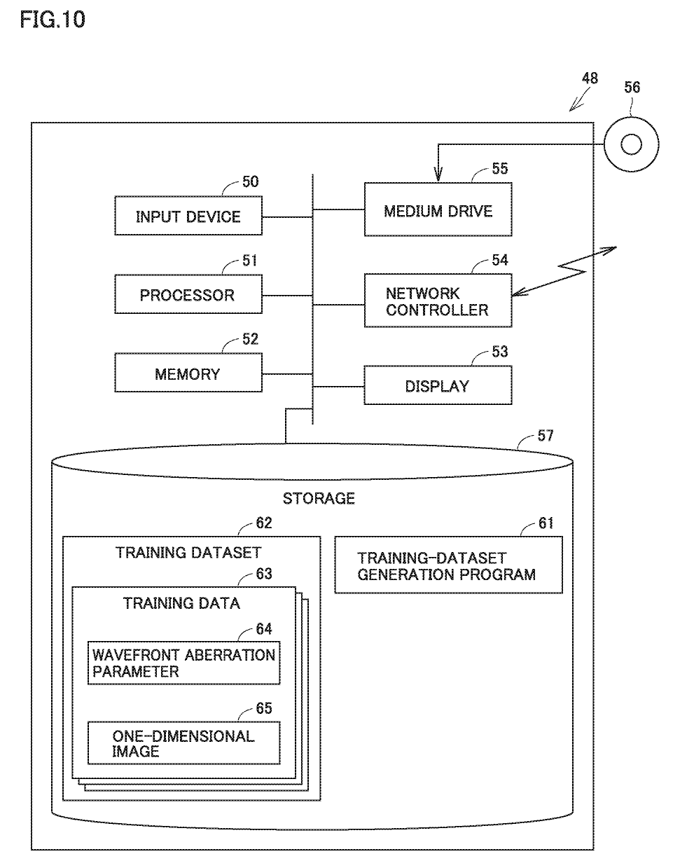

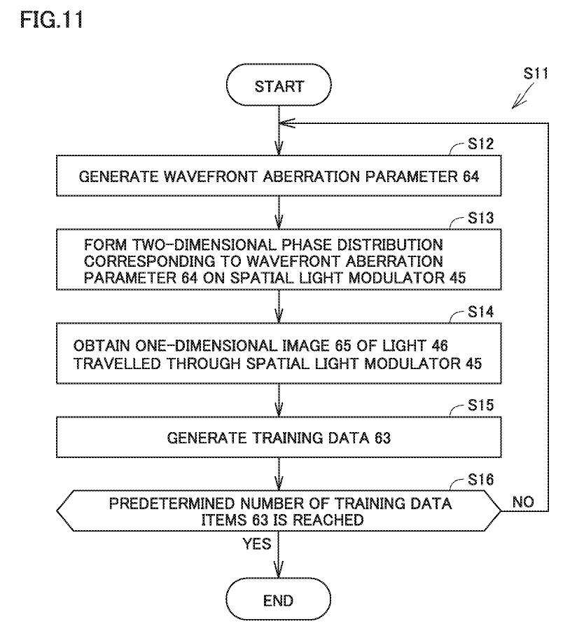

Referring to FIGS. 9 to 12C, step S11 (see FIG. 8) is now described. In step S11, training dataset 62 (see FIG. 10) is generated using a training-dataset generation device 40 (see FIG. 9). Step S11 is performed by a processor 51 (see FIG. 10) of training-dataset generation device 40 executing a training-dataset generation program 61 (see FIG. 10).

### Training-dataset Generation Device 40

Training-dataset generation device 40 includes a light source 41, a collimating lens 44, a spatial light modulator 45, line-focusing element 15, line sensor 16, a training-data generator 48, and a controller 49. Training-dataset generation device 40 may further include an aperture 43. Training-dataset generation device 40 may further include two-dimensional focusing element 10 and mask 11.

Light source 41 is, for example, a light-emitting device such as a laser light source or a superluminescent diode (SLD). Light source 41 emits light 42. Referring to FIG. 1, if wavefront sensor 1 is applied to a receiver device of an optical satellite communications device, light source 3 is, for example, mounted on a satellite, residing sufficiently remote from the surface of the Earth on which the wavefront sensor 1 is mounted. Therefore, light source 3 can be regarded as a point light source. Thus, in order for light source 41 to be regarded as a point light source, aperture 43 may be disposed between light source 41 and collimating lens 44.

Collimating lens 44 is disposed between light source 41 and spatial light modulator 45. Collimating lens 44 may be disposed between aperture 43 and spatial light modulator 45. Referring to FIG. 1, if wavefront sensor 1 is applied to a receiver device of an optical satellite communications device, light source 3 is, for example, mounted on a satellite, residing sufficiently remote from the surface of the Earth on which the wavefront sensor 1 is mounted. Therefore, light 4 emitted from light source 3 reaches medium 6, as a plane wave. Thus, in order for light 42 emitted from light source 41 to reach spatial light modulator 45 as a plane wave, collimating lens 44 collimates light 42 emitted from light source 41 to convert light 42 into a plane wave. Collimating lens 44 may be, but not particularly limited to, a plano convex lens.

Spatial light modulator 45 is disposed between collimating lens 44 and two-dimensional focusing element 10 on an optical path 47 of light 42 and 46. Spatial light modulator 45 is disposed on the front focal plane of two-dimensional focusing element 10. For example, spatial light modulator 45 may be a transmissive spatial light modulator such as a liquid-crystal spatial light modulator (LC-SLM), or a reflective spatial light modulator such as an LCOS (Liquid Crystal on Silicon) spatial light modulator or a MEMS (Micro-Electro-Mechanical Systems) spatial light modulator. Spatial light modulator 45 can be controlled by controller 49. The spatial light modulator receives the wavefront aberration signal from controller 49 to form a two-dimensional phase distribution. Light 42 travels through spatial light modulator 45 and turns to light 46. The wavefront aberration due to the two-dimensional phase distribution formed on spatial light modulator 45 is a difference between the wavefront of light 42 and the wavefront of light 46.

Two-dimensional focusing element 10 (see FIG. 9), included in training-dataset generation device 40, is configured in a manner similar to two-dimensional focusing element 10 (see FIG. 1) included in wavefront sensor 1. Two-dimensional focusing element 10 of training-dataset generation device 40 is disposed between spatial light modulator 45 and mask 11 on optical path 8 of light 46. Light 46 is incident on two-dimensional focusing element 10. Two-dimensional focusing element 10 isotropically focuses light 46 in a plane orthogonal to optical path 47 of light 46. Two-dimensional focusing element 10 may be, but not particularly limited to, a spherical lens such as a plano convex lens or a bioconvex lens, or at least one curved mirror.

Mask 11 (see FIG. 9), included in training-dataset generation device 40, is configured in a manner similar to mask 11 (see FIG. 1) included in wavefront sensor 1. Mask 11 of training-dataset generation device 40 is disposed on the rear focal plane of two-dimensional focusing element 10 and on the front focal plane of line-focusing element 15. Mask 11 of training-dataset generation device 40 includes: central light-shielding region 12; peripheral light-shielding region 13; and annular opening 14 formed between central light-shielding region 12 and peripheral light-shielding region 13. Light 46 passes through annular opening 14. Central light-shielding region 12 of mask 11 blocks an image of light source 41, enabling line sensor 16 to accurately detect light 46.

Line-focusing element 15 (see FIG. 9), included in training-dataset generation device 40, is configured in a manner similar to line-focusing element 15 (see FIG. 1) included in wavefront sensor 1. Line-focusing element 15 of training-dataset generation device 40 is disposed between mask 11 and line sensor 16 on optical path 8 of light 46. Line-focusing element 15 focuses light 7 primary in the direction orthogonal to the arrangement direction of the pixels of line sensor 16. In this manner, line-focusing element 15 focuses light 46 in a line. Line-focusing element 15 may be, for example, a line-focusing lens such as a cylindrical lens, or at least one curved mirror.

Line sensor 16 (see FIG. 9), included in training-dataset generation device 40, is configured in a manner similar to line sensor 16 (see FIG. 1) of wavefront sensor 1. Line sensor 16 is disposed on the rear focal plane of line-focusing element 15. Line sensor 16 receives light 46, focused in a line by line-focusing element 15, to obtain a one-dimensional image 65 (see FIG. 10) of light 46. Line sensor 16 outputs one-dimensional image 65 of light 46 to wavefront aberration estimator 20. Line sensor 16 has a frame rate of 10 kHz or higher, for example. Line sensor 16 may have a frame rate of 50 kHz or higher, or 100 kHz or higher.

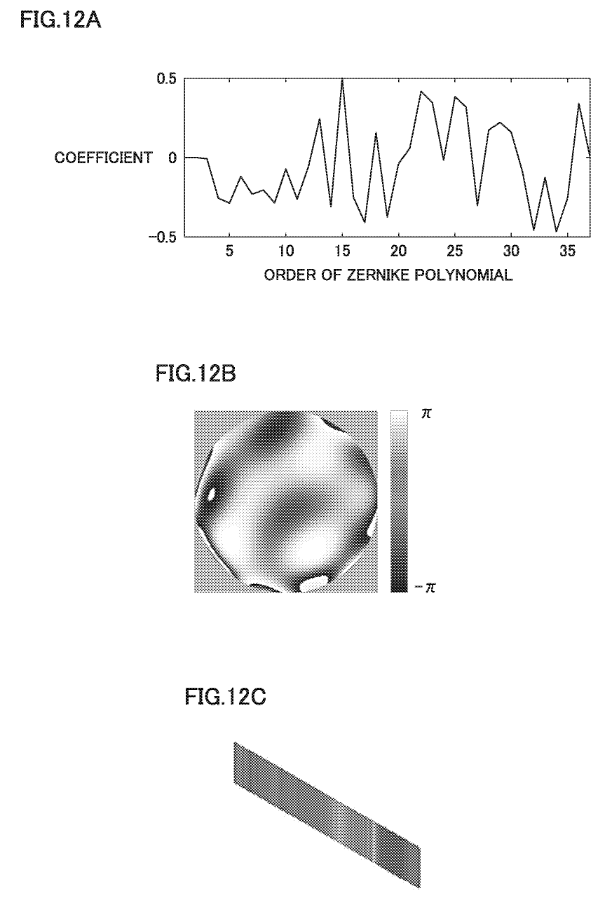

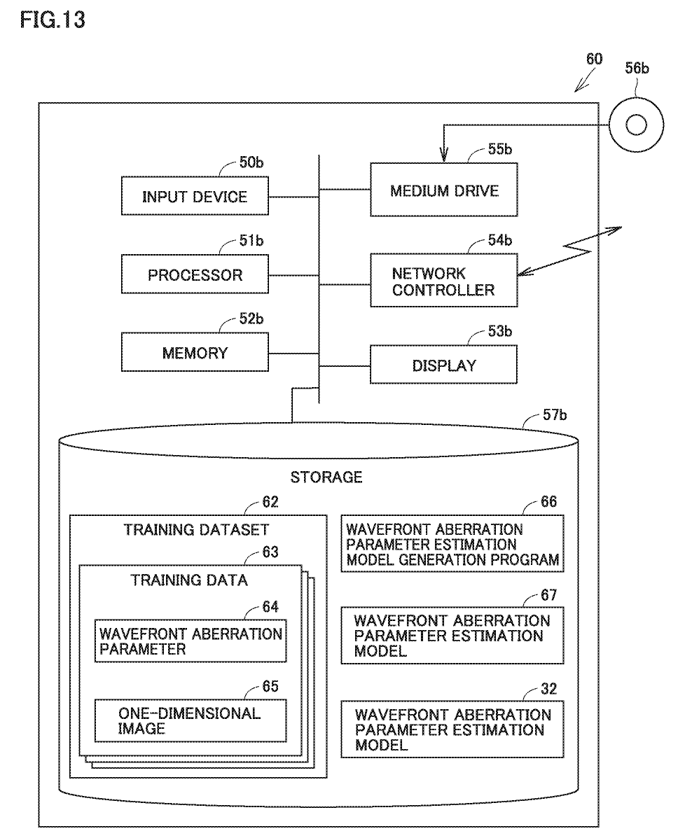

Training-data generator 48 generates a wavefront aberration parameter 64 (see FIG. 10). Training-data generator 48 outputs wavefront aberration parameter 64 to controller 49. For example, wavefront aberration parameter 64 is a set of coefficients of a Zernike polynomial (see FIG. 12A). Training-data generator 48 also receives one-dimensional image 65 of light 46 (see FIG. 10) from line sensor 16. Furthermore, training-data generator 48 generates training data 63 (see FIG. 10), which is a set of wavefront aberration parameter 64 and one-dimensional image 65 corresponding to wavefront aberration parameter 64. Training-data generator 48 generates training dataset 62 (see FIG. 10) consisting of a plurality of training data 63. Training data 63 differ from each other in wavefront aberration parameter 64.

Controller 49 receives wavefront aberration parameter 64 from training-data generator 48 to generate a wavefront aberration signal corresponding to wavefront aberration parameter 64. Controller 49 outputs the wavefront aberration signal to spatial light modulator 45. Controller 49 controls spatial light modulator 45.

For example, controller 49 is a microcomputer that includes a processor, a random access memory (RAM), and a memory device such as a read only memory (ROM). For example, a CPU or a GPU can be employed as the processor. The RAM functions as a working memory temporarily storing the data processed by the processor. The memory device, for example, stores programs that are executed the processor. In the present embodiment, as the processor executes the programs stored in the memory device, controller 49 controls spatial light modulator 45. An FPGA may be adopted as controller 49, instead of the microcomputer. The various processes at controller 49 are not limited to be performed by software, and may be implemented by dedicated hardware (an electronic circuit).

### Hardware Configuration of Training-data Generator 48

Referring to FIG. 10, a hardware configuration of training-data generator 48 is now described. Training-data generator 48 includes an input device 50, processor 51, a memory 52, a display 53, a network controller 54, a medium drive 55, and a storage 57.

Input device 50 receives various input operations. Input device 50 is, for example, a keyboard, a mouse, or a touch panel.

For example, display 53 shows training dataset 62, and information that are necessary for the process by training-data generator 48. Display 53 is an LCD or an organic EL display, for example.

Processor 51 executes training-dataset generation program 61, thereby performing processes that are required to implement the functions of training-data generator 48. Processor 51 is configured of, for example, a CPU or a GPU.

In processor 51 executing training-dataset generation program 61, etc., memory 52 provides a storage area for temporarily storing program codes or a work memory, for example. For example, memory 52 is a volatile memory device such as a DRAM or an SRAM.

Network controller 54 transmits/receives programs or data to/from any device through a communication network (not shown) such as the Internet or the Intranet. For example, network controller 54 transmits training dataset 62 to wavefront aberration parameter estimation model generation device 60 (see FIG. 13), a display (not shown), or a memory device (not shown) through the communication network. For example, network controller 54 supports any communication scheme such as Ethernet (registered trademark), a wireless LAN, or Bluetooth (registered trademark).

Medium drive 55 is a device for reading programs or data stored in a computer-readable medium 56. Medium drive 55 may further be a device for writing programs or data into computer-readable medium 56. Computer-readable medium 56 is a non-transitory storage medium, storing programs or data in a non-volatile manner. For example, computer-readable medium 56 is an optical storage medium such as an optical disk (e.g., CD-ROM or DVD-ROM), a semiconductor storage medium such as a flash memory or a USB memory, a magnetic storage medium such as a hard disk, an FD, or a storage tape, or a magneto-optical storage media such as an MO disk.

For example, storage 57 stores data such as training dataset 62, and programs (such as training-dataset generation program 61) that are performed by processor 51. Storage 57 is a nonvolatile memory device such as a hard disk or an SSD, for example.

The programs for implementing the functions of training-data generator 48 may be distributed in the form of a non-transitory computer-readable medium 56 or installed in storage 57. The programs for implementing the functions of training-data generator 48 may be downloaded to training-data generator 48 through a communication network such as the Internet or the Intranet. The programs for implementing the functions of training-data generator 48 include training-dataset generation program 61.

In the present embodiment, the functions of training-data generator 48 are implemented by a general purpose computer (processor 51) executing programs. However, the present disclosure is not limited thereto. All or some of the functions of training-data generator 48 may be implemented using an integrated circuit such as an ASIC or a FPGA.

### Method of Generation of Training Dataset 62

Referring to FIG. 11, a method of generation of training dataset 62 is now described.

Training-data generator 48 generates wavefront aberration parameter 64 (step S12). For example, wavefront aberration parameter 64 is a set of coefficients of a Zernike polynomial (see FIG. 12A). Training-data generator 48 outputs wavefront aberration parameter 64 to controller 49 and storage 57. Storage 57 stores wavefront aberration parameter 64.

A two-dimensional phase distribution corresponding to wavefront aberration parameter 64 is formed on spatial light modulator 45 (step S13). Specifically, controller 49 receives wavefront aberration parameter 64 from training-data generator 48. Controller 49 generates a wavefront aberration signal corresponding to wavefront aberration parameter 64, from wavefront aberration parameter 64. Controller 49 outputs the wavefront aberration signal to spatial light modulator 45. Spatial light modulator 45 receives the wavefront aberration signal from controller 49 to form a two-dimensional phase distribution (see FIG. 12B). The wavefront aberration due to the two-dimensional phase distribution, formed on spatial light modulator 45, is a wavefront aberration represented by wavefront aberration parameter 64 generated by training-data generator 48.

One-dimensional image 65 of light 46 travelled through spatial light modulator 45 is obtained (step S14).

Specifically, light source 41 emits light 42. Light 42 passes through aperture 43 and collimating lens 44, travels through spatial light modulator 45, and turns to light 46. The wavefront aberration due to the two-dimensional phase distribution formed on spatial light modulator 45 is a difference between the wavefront of light 42 and the wavefront of light 46. Two-dimensional focusing element 10 isotropically focuses light 46 in a plane orthogonal to optical path 47 of light 46. Central light-shielding region 12 of mask 11 blocks an image of light source 41. Light 46 passes through annular opening 14 in mask 11 and is incident on line-focusing element 15. Line-focusing element 15 focuses light 46 in a line. Line sensor 16 receives light 46, focused in a line by line-focusing element 15, to obtain a one-dimensional image 65 (see FIG. 12C) of light 46.

Line sensor 16 outputs one-dimensional image 65 of light 46 to training-data generator 48. Training-data generator 48 receives one-dimensional image 65 of light 46 from line sensor 16. Storage 57, included in training-data generator 48, stores one-dimensional image 65 of light 46.

Training-data generator 48 generates training data 63 (step S15). Training-data generator 48 generates, as training data 63, a set of wavefront aberration parameter 64 generated in step S12 and one-dimensional image 65 obtained in step S14. Storage 57 of training-data generator 48 stores training data 63.

Training-data generator 48 determines whether a predetermined number of training data items 63 is reached (step S16). If training-data generator 48 determines that the predetermined number of training data items 63 is not reached, training-data generator 48 generates another wavefront aberration parameter 64 in step S12 and performs steps S12 to S16 again. If training-data generator 48 determines that the predetermined number of training data items 63 is reached, training-data generator 48 ends the generation of training data 63. In this manner, steps S12 to S16 are repeated until the predetermined number of training data items 63 is reached. Training-data generator 48 generates training dataset 62 consisting of the plurality of training data 63. Storage 57 of training-data generator 48 stores training dataset 62.

Training dataset 62 may be generated by simulating, on a computer, the optics (light source 41, aperture 43, two-dimensional focusing element 10, mask 11, line-focusing element 15, and line sensor 16) of training-dataset generation device 40, and the method of generation of training dataset 62.

### Step S20

Referring to FIGS. 13 to 16, step S20 (see FIG. 8) is now described. In step S20, wavefront aberration parameter estimation model 67 is trained by machine learning, using wavefront aberration parameter estimation model generation device 60 (see FIG. 13).

### Hardware Configuration of Wavefront Aberration Parameter Estimation Model Generation Device 60

Referring to FIG. 13, a hardware configuration of wavefront aberration parameter estimation model generation device 60 is now described. Wavefront aberration parameter estimation model generation device 60 includes an input device 50b, a processor 51b, a memory 52b, a display 53b, a network controller 54b, a medium drive 55b, and a storage 57b.

Input device 50b receives various input operations. Input device 50b is, for example, a keyboard, a mouse, or a touch panel.

For example, display 53b shows information that are necessary for the process by wavefront aberration parameter estimation model generation device 60. Display 53b is an LCD or an organic EL display, for example.

Processor 51b executes a wavefront aberration parameter estimation model generation program 66, thereby performing processes that are required to implement the functions of wavefront aberration parameter estimation model generation device 60.

Processor 51b is configured of, for example, a CPU or a GPU.

In processor 51b executing wavefront aberration parameter estimation model generation program 66, memory 52b provides a storage area for temporarily storing program codes or a work memory, for example. For example, memory 52b is a volatile memory device such as a DRAM or an SRAM.

Network controller 54b receives, for example, training dataset 62 (see FIG. 10) from training-data generator 48 (see FIGS. 9 and 10) through a communication network. For example, network controller54b transmits wavefront aberration parameter estimation model 32 to wavefront aberration estimator 20 (see FIG. 1), a display (not shown), or a memory device (not shown) through the communication network. Network controller 54b supports any communication scheme such as Ethernet (registered trademark), a wireless LAN, or Bluetooth (registered trademark).

Medium drive 55b is a device for reading programs or data stored in a computer-readable medium 56b. Medium drive 55b may further be a device for writing programs or data into computer-readable medium 56b. Computer-readable medium 56b is a non-transitory storage medium, storing programs or data in a non-volatile manner. For example, computer-readable medium 56b is an optical storage medium such as an optical disk (e.g., CD-ROM or DVD-ROM), a semiconductor storage medium such as a flash memory or a USB memory, a magnetic storage medium such as a hard disk, an FD or a storage tape, or a magneto-optical storage media such as an MO disk.

For example, storage 57b stores training dataset 62, wavefront aberration parameter estimation models 32 and 67, wavefront aberration parameter estimation model generation program 66, etc. For example, storage 57b is a nonvolatile memory device such as a hard disk or an SSD.

Programs for implementing the functions of wavefront aberration parameter estimation model generation device 60 may be distributed in the form of a non-transitory computer-readable medium 56b and installed in storage 57b. The programs for implementing the functions of wavefront aberration parameter estimation model generation device 60 may be download to wavefront aberration parameter estimation model generation device 60 through a communication network such as the Internet or the Intranet. The programs for implementing the functions of wavefront aberration parameter estimation model generation device 60 include wavefront aberration parameter estimation model generation program 66.

In the present embodiment, the functions of wavefront aberration parameter estimation model generation device 60 are implemented by a general purpose computer (processor 51) executing the program. However, the present disclosure is not limited thereto. All or some of the functions of wavefront aberration parameter estimation model generation device 60 may be implemented using an integrated circuit such as an ASIC or a FPGA.

### Functional Configuration of Wavefront Aberration Parameter Estimation Model Generation Device 60

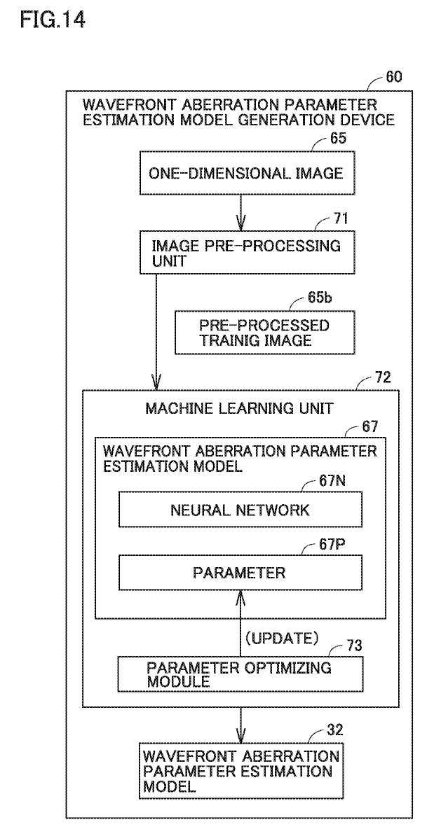

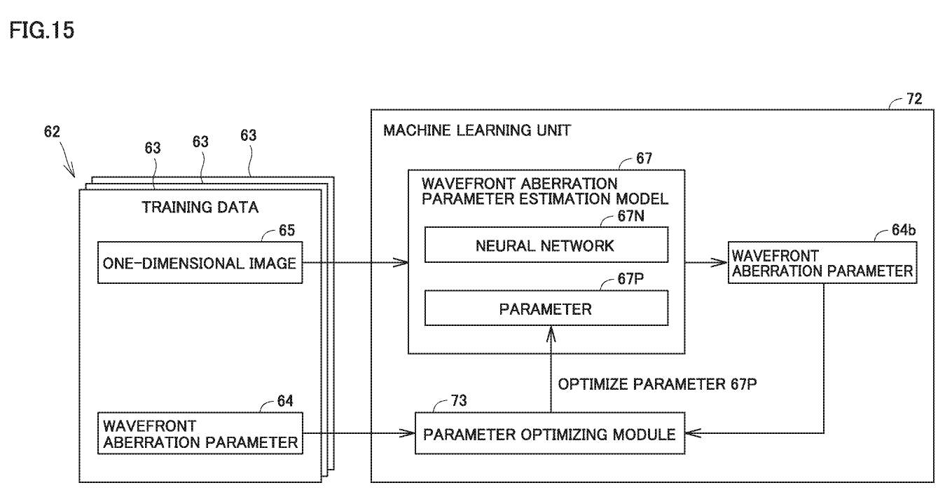

Referring to FIGS. 14 and 15, a functional configuration of wavefront aberration parameter estimation model generation device 60 is now described. Wavefront aberration parameter estimation model generation device 60 includes an image pre-processing unit 71 and a machine learning unit 72.

Referring to FIG. 14, image pre-processing unit 71 pre-processes one-dimensional image 65 of training data 63 to generate a pre-processed training image 65b. For example, image pre-processing unit 71 applies pre-processes such as correcting white balance, correcting contrast, resizing, normalization, de-noising, or filtering to one-dimensional image 65 of training data 63. If wavefront aberration parameter estimation models 32 and 67 include a convolutional neural network (CNN), image pre-processing unit 71 may convert one-dimensional image 65 of training data 63 into a two-dimensional image and generate the two-dimensional image as the pre-processed training image 65b. For example, one-dimensional image 65 of training data 63 is converted into a two-dimensional image by two-dimensionally rearranging (reshaping) the pixels of one-dimensional image 65. Image pre-processing unit 71 outputs the pre-processed training image 65b to machine learning unit 72.

Referring to FIGS. 14 and 15, machine learning unit 72 generates wavefront aberration parameter estimation model 32 by training wavefront aberration parameter estimation model 67 by machine learning using the pre-processed training image 65b and wavefront aberration parameter 64 of training data 63 corresponding to the pre-processed training image 65b.

Machine learning unit 72 includes wavefront aberration parameter estimation model 67 and a parameter optimizing module 73. Wavefront aberration parameter estimation model 67 includes a neural network 67N and a parameter 67P. Neural network 67N is a neural network categorized as a deep neural network (DNN). Neural network 67N may include a convolutional neural network (CNN). Neural network 67N is the same as neural network 32N. Neural network 67N is pre-built and stored in storage 57 of wavefront aberration parameter estimation model generation device 60. Parameter optimizing module 73 is a program module for optimizing parameter 67P. Machine learning unit 72 updates the value of parameter 67P of wavefront aberration parameter estimation model 67 by machine learning using the pre-processed training image 65b and wavefront aberration parameter 64.

Specifically, machine learning unit 72 inputs the pre-processed training image 65b to wavefront aberration parameter estimation model 67 and causes wavefront aberration parameter estimation model 67 to output a wavefront aberration parameter 64b. Parameter optimizing module 73 calculates an error between wavefront aberration parameter 64b output from wavefront aberration parameter estimation model 67 and wavefront aberration parameter 64 of training data 63. Parameter optimizing module 73 optimizes parameter 67P of wavefront aberration parameter estimation model 67 so that the error is minimized. Any optimization algorithm can be used to optimize parameter 67P. For example, a gradient method such as a stochastic gradient descent (SGD), a Momentum SGD, AdaGrad, RMSprop, AdaDelta or Adam (Adaptive moment estimation) can be used as the optimization algorithm.

Similarly, machine learning unit 72 repeatedly optimizes parameter 67P of wavefront aberration parameter estimation model 67, using the plurality of training data 63 of training dataset 62. In this manner, machine learning unit 72 generates the trained wavefront aberration parameter estimation model 67, which includes the optimized parameter 67P, as wavefront aberration parameter estimation model 32. The optimized parameter 67P is parameter 32P (see FIG. 3). Machine learning unit 72 outputs wavefront aberration parameter estimation model 32 to storage 57 of wavefront aberration parameter estimation model generation device 60.

### Method of Training Wavefront Aberration Parameter Estimation Model 32

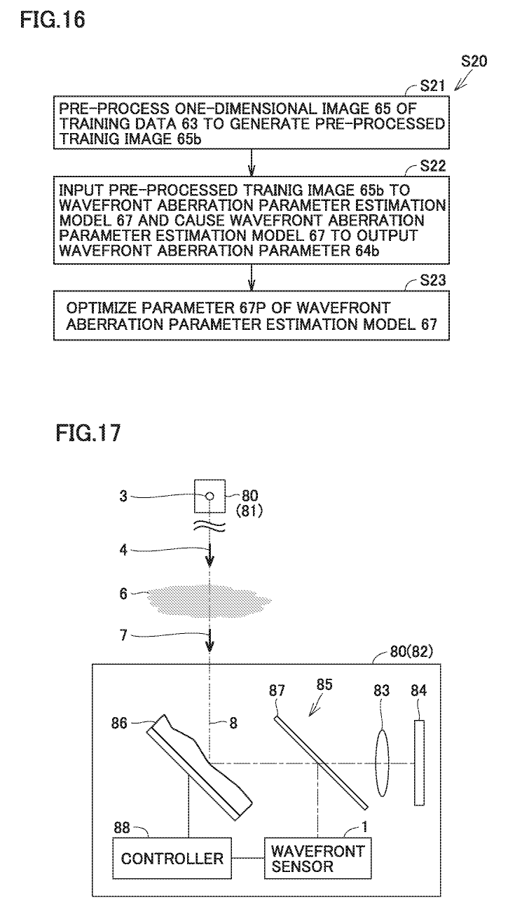

Referring to FIG. 16, a method of training wavefront aberration parameter estimation model 32 by machine learning using wavefront aberration parameter estimation model generation device 60, is now described.

Image pre-processing unit 71 reads training data 63 from storage 57 of wavefront aberration parameter estimation model generation device 60. Image pre-processing unit 71 pre-processes one-dimensional image 65 of training data 63 to generate the pre-processed training image 65b (step S21). For example, image pre-processing unit 71 applies pre-processes such as correcting white balance, correcting contrast, resizing, normalization, de-noising, or filtering to one-dimensional image 65 of training data 63. Image pre-processing unit 71 outputs the pre-processed training image 65b to machine learning unit 72.

If wavefront aberration parameter estimation models 32 and 67 include a convolutional neural network (CNN), image pre-processing unit 71 may convert one-dimensional image 65 of training data 63 into a two-dimensional image and generate the two-dimensional image as the pre-processed training image 65b. For example, image pre-processing unit 71 converts one-dimensional image 65 of training data 63 into a two-dimensional image by two-dimensionally rearranging (reshaping) the pixels of one-dimensional image 33.

Machine learning unit 72 receives the pre-processed training image 65b from image pre-processing unit 71. Machine learning unit 72 inputs the pre-processed training image 65b to wavefront aberration parameter estimation model 67 and causes wavefront aberration parameter estimation model 67 to output wavefront aberration parameter 64b (step S22). Parameter optimizing module 73 of machine learning unit 72 calculates an error between wavefront aberration parameter 64b output from wavefront aberration parameter estimation model 67 and wavefront aberration parameter 64 of training data 63. Parameter optimizing module 73 optimizes parameter 67P of wavefront aberration parameter estimation model 67 so that the error is minimized (step S23).

Similarly, machine learning unit 72 repeatedly optimizes parameter 67P of wavefront aberration parameter estimation model 67, using the plurality of training data 63 of training dataset 62. In this manner, machine learning unit 72 generates the trained wavefront aberration parameter estimation model 67 including the optimized parameter 67P, as wavefront aberration parameter estimation model 32. The optimized parameter 67P is parameter 32P (see FIG. 3). Machine learning unit 72 outputs wavefront aberration parameter estimation model 32 to storage 57 of wavefront aberration parameter estimation model generation device 60. Storage 57 of wavefront aberration parameter estimation model generation device 60 stores wavefront aberration parameter estimation model 32.

Step S20 is performed by processor 51 (see FIG. 10) of wavefront aberration parameter estimation model generation device 60, executing wavefront aberration parameter estimation model generation program 66 (see FIG. 10).

### Adaptive Optics Apparatus 85

Referring to FIG. 17, an adaptive optics apparatus 85 according to the present embodiment is now described. Adaptive optics apparatus 85 is applicable to a receiver device 82 of an optical satellite communications device 80, for example.

Optical satellite communications device 80 includes a transmitter device 81 and receiver device 82. Transmitter device 81 is, for example, mounted on a satellite. Transmitter device 81 includes light source 3. Light source 3 is, for example, mounted on a satellite. Light source 3 is, for example, a laser light source or a superluminescent diode (SLD). Receiver device 82 is, for example, is mounted on the surface of the Earth. Receiver device 82 includes an imaging lens 83 and a photodetector 84. Photodetector 84 is an image sensor, for example.

Light source 3 emits light 4. Light 4 travels through medium 6. Upon receiving the aberration of medium 6, light 4 turns to light 7 that has a disturbed wavefront. The wavefront aberration due to medium 6 is a difference between the wavefront of light 4 and the wavefront of light 7. Imaging lens 83 images light 7 on photodetector 84. Photodetector 84 receives light 7.

In order to eliminate the impact of the aberration of medium 6, receiver device 82 further includes adaptive optics apparatus 85. Adaptive optics apparatus 85 includes a beam splitter 87, wavefront sensor 1, a spatial light modulator 86, and a controller 88.

Beam splitter 87 splits light 7 into first light toward photodetector 84 and second light toward wavefront sensor 1. The first light is incident on photodetector 84. The second light is incident on wavefront sensor 1. Wavefront sensor 1 obtains one-dimensional image 33 of light 7 (see FIG. 3). Wavefront sensor 1 estimates the wavefront aberration due to medium 6 from one-dimensional image 33. Specifically, wavefront sensor 1 outputs wavefront aberration parameter 34 (see FIG. 3) representing the wavefront aberration due to medium 6. Wavefront sensor 1 outputs wavefront aberration parameter 34 to controller 88.

Controller 88 is communicatively connected to spatial light modulator 86 and wavefront sensor 1. Controller 88 receives wavefront aberration parameter 34 (see FIG. 3) from wavefront sensor 1 to generate a compensating wavefront aberration signal corresponding to wavefront aberration parameter 34. Controller 88 outputs the compensating wavefront aberration signal to spatial light modulator 86.

For example, controller 88 is a microcomputer that includes a processor, a RAM, and a memory device such as a ROM. For example, a CPU or a GPU can be employed as the processor. The RAM functions as a working memory temporarily storing the data processed by the processor. The memory device, for example, stores programs that are executed by the processor. In the present embodiment, as the processor executes the programs stored in the memory device, controller 88 controls spatial light modulator 86. An FPGA may be adopted as controller 88, instead of the microcomputer. The various processes at controller 88 are not limited to be performed by software and may be implemented by dedicated hardware (an electronic circuit).

On optical path 8 of light 7, spatial light modulator 86 is disposed on the light 7 incident side of beam splitter 87. For example, spatial light modulator 86 is, but not particularly limited to, an LCOS spatial light modulator, a digital micromirror device (DMD) including two-dimensionally arranged MEMS mirrors, or a deformable mirror utilizing a piezo actuator. Spatial light modulator 86 can be controlled by controller 88. Spatial light modulator 86 receives the compensating wavefront aberration signal from controller 88 to form a two-dimensional phase distribution. Spatial light modulator 86 provides light 7 to a compensating wavefront aberration due to the two-dimensional phase distribution. The compensating wavefront aberration cancels the wavefront aberration due to medium 6. Therefore, the impact of the aberration of medium 6 can be eliminated from the output signal of photodetector 84.

Receiver device 82, of optical satellite communications device 80 including adaptive optics apparatus 85, may be mounted on a satellite, and transmitter device 81, of the optical satellite communications device including light source 3, may be mounted on the surface of the Earth.

Advantages effects of wavefront sensor 1 and adaptive optics apparatus 85 according to the present embodiment are now described.

Wavefront sensor 1 according to the present embodiment includes line-focusing element 15, line sensor 16, and wavefront aberration estimator 20. Line-focusing element 15 focuses, in a line, light 7 travelled through medium 6. Line sensor 16 receives light 7, focused in a line by line-focusing element 15, to obtain one-dimensional image 33 of light 7. Wavefront aberration estimator 20 includes image pre-processing unit 37 and wavefront aberration parameter estimation unit 38. Image pre-processing unit 37 pre-processes one-dimensional image 33 to generate pre-processed image 33b. Wavefront aberration parameter estimation unit 38 inputs pre- processed image 33b to wavefront aberration parameter estimation model 32 trained by machine learning and causes wavefront aberration parameter estimation model 32 to output wavefront aberration parameter 34 representing the wavefront aberration due to medium 6.

Comparative Example, like a wavefront sensor by diffraction imaging, requires recursive computations to obtain the amplitude and phase of light from a two-dimensional intensity image. Wavefront sensor 1 according to the present embodiment, in contrast, uses wavefront aberration parameter estimation model 32, trained by machine learning, to obtain wavefront aberration parameter 34 representing the wavefront aberration due to medium 6. Therefore, wavefront sensor 1 according to the present embodiment can obtain wavefront aberration parameter 34, without having to perform recursive computations. Moreover, wavefront sensor 1 according to the present embodiment includes line sensor 16 and line-focusing element 15. The upper-limit frame rate of line sensor 16 in specifications is higher than the upper-limit frame rate of the two-dimensional image sensor in specifications. Moreover, line-focusing element 15 can increase the light intensity per pixel of line sensor 16 across the pixels of line sensor 16 better than a spherical lens. Therefore, line sensor 16 can obtain one-dimensional image 33 of light 7 at a higher frame rate. Wavefront sensor 1 can perform faster sensing of the wavefront aberration due to medium 6. For example, the application of wavefront sensor 1 to optical satellite communications device prevents atmospheric fluctuations at 10 kHz or higher from making a negative impact on the communication quality. Wavefront sensor 1 enables Terabit-per-second (Tbps) optical satellite communications.

In wavefront sensor 1 according to the present embodiment, line sensor 16 has a frame rate of 100 kHz or higher.

Therefore, wavefront sensor 1 can perform faster sensing of the wavefront aberration due to medium 6.

Wavefront sensor 1 according to the present embodiment further includes two-dimensional focusing element 10 and mask 11. Line-focusing element 15 is disposed between mask 11 and line sensor 16 on optical path 8 of light 7. On optical path 8 of light 7, mask 11 is disposed between two-dimensional focusing element 10 and line-focusing element 15 and on the focal plane of two-dimensional focusing element 10. Mask 11 includes: central light-shielding region 12; peripheral light-shielding region 13; and annular opening 14 formed between central light-shielding region 12 and peripheral light-shielding region 13.

Therefore, central light-shielding region 12 blocks an image of light source 3 of light 7. Line sensor 16 accurately detects light 7 undergone the aberration of medium 6. Wavefront sensor 1 can perform more accurate sensing of the wavefront aberration due to medium 6.

In wavefront sensor 1 according to the present embodiment, image pre-processing unit 37 rearranges the pixels of one-dimensional image 33 to generate a two-dimensional image from one-dimensional image 33, as pre-processed image 33b. Wavefront aberration parameter estimation model 32 includes a convolutional neural network. Wavefront aberration parameter estimation unit 38 inputs the two-dimensional image to wavefront aberration parameter estimation model 32 and causes wavefront aberration parameter estimation model 32 to output wavefront aberration parameter 34.

The wavefront aberration due to medium 6 is an aberration that is distributed two-dimensionally. Therefore, wavefront aberration parameter 34 can be obtained at a higher speed by converting one-dimensional image 33 into a two-dimensional image and inputting the two-dimensional image to wavefront aberration parameter estimation model 32 including the convolutional neural network. Wavefront sensor 1 can perform faster sensing of the wavefront aberration due to medium 6.

In wavefront sensor 1 according to the present embodiment, light 7 is emitted from a laser light source or a superluminescent diode.

Therefore, light 7 has higher coherency. Due to the coherency of light 7, speckles are formed on line sensor 16. The speckles enhance the contrast of light 7 on line sensor 16. Therefore, line sensor 16 is allowed to obtain one-dimensional image 33 of light 7 at an even higher frame rate. Wavefront sensor 1 can perform faster sensing of the wavefront aberration due to medium 6.

Adaptive optics apparatus 85 according to the present embodiment includes wavefront sensor 1, spatial light modulator 86, and controller 88. Controller 88 is communicatively connected to spatial light modulator 86 and wavefront sensor 1, and can control spatial light modulator 86. Controller 88 receives, from wavefront sensor 1, wavefront aberration parameter 34 representing the wavefront aberration due to medium 6 and causes spatial light modulator 86 to form a two-dimensional phase distribution. The compensating wavefront aberration due to the two-dimensional phase distribution cancels the wavefront aberration due to medium 6.

Since adaptive optics apparatus 85 includes wavefront sensor 1, adaptive optics apparatus 85 can compensate for the wavefront aberration due to medium 6 at a higher speed. For example, the application of adaptive optics apparatus 85 to receiver device 82 of optical satellite communications device 80 prevents atmospheric fluctuations at 10 kHz or higher from making a negative impact on the communication quality. Adaptive optics apparatus 85 enables Terabit-per-second (Tbps) optical satellite communications.

### Embodiment 2

### Wavefront Sensor 1

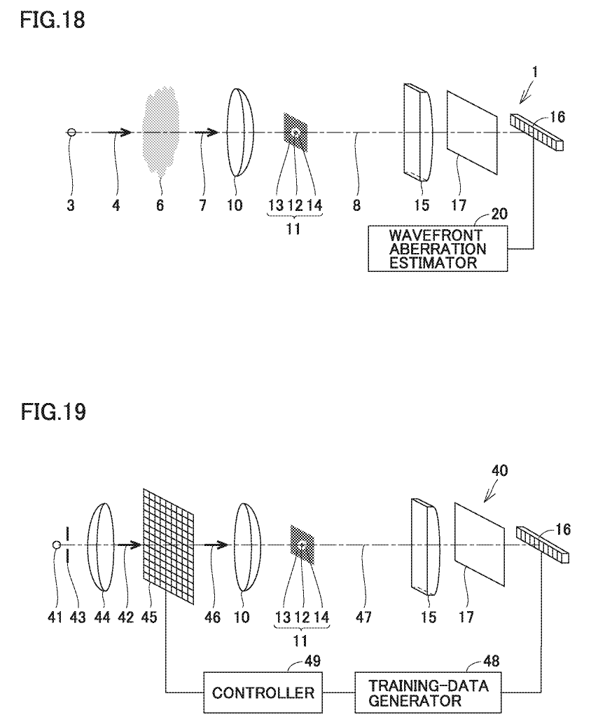

Referring to FIG. 18, a wavefront sensor 1 according to Embodiment 2 is now described. Wavefront sensor 1 according to the present embodiment has the same configuration as wavefront sensor 1 according to Embodiment 1, except for further including a light-scattering plate 17.

Light-scattering plate 17 is disposed between a line-focusing element 15 and a line sensor 16 on an optical path 8 of light 7. Light-scattering plate 17 scatters light 7. Line sensor 16 obtains a one-dimensional image 33 of light 7 scattered by light-scattering plate 17 (see FIG. 2). Even if a wavefront aberration due to a medium 6 is small, a photodetector 84 can obtain one-dimensional image 33 in which the wavefront aberration due to medium 6 is enhanced by light-scattering plate 17. Therefore, wavefront sensor 1 can perform more accurate, and faster sensing of the wavefront aberration due to medium 6.

Referring to FIG. 19, a training-dataset generation device 40 according to the present embodiment has the same configuration as training-dataset generation device 40 according to Embodiment 1, except for further including light-scattering plate 17. As with light-scattering plate 17 of wavefront sensor 1 according to the present embodiment, light-scattering plate 17 included in training-dataset generation device 40 according to the present embodiment is disposed between line-focusing element 15 and line sensor 16.

Referring to FIG. 11, a method of generation of a training dataset 62 according to the present embodiment is the same as the method of generation of training dataset 62 according to Embodiment 1, except for using training-dataset generation device 40 according to the present embodiment (see FIG. 19) to generate training dataset 62. Note that the training dataset 62 may be generated by simulating, on a computer, the optics (a light source 41, an aperture 43, a two-dimensional focusing element 10, a mask 11, line-focusing element 15, light-scattering plate 17, and a line sensor 16) of training-dataset generation device 40 according to the present embodiment, and the method of generation of training dataset 62 according to the present embodiment.

Referring to FIGS. 13 to 16, a method of training a wavefront aberration parameter estimation model 32 and a wavefront aberration parameter estimation model generation device 60 according to the present embodiment are the same as the method of training wavefront aberration parameter estimation model 32 and wavefront aberration parameter estimation model generation device 60 according to Embodiment 1.

### Adaptive Optics Apparatus 85

Referring to FIG. 17, an adaptive optics apparatus 85 according to the present embodiment is now described. While adaptive optics apparatus 85 according to the present embodiment has the same configuration as adaptive optics apparatus 85 according to Embodiment 1, adaptive optics apparatus 85 according to the present embodiment includes wavefront sensor 1 according to the present embodiment (see FIG. 18), instead of wavefront sensor 1 according to Embodiment 1. Therefore, adaptive optics apparatus 85 can more accurately compensates for the wavefront aberration due to medium 6 at a higher speed.

In the following, aspects of the present disclosure are collectively described as clauses:

### Clause 1

A wavefront sensor, comprising:

a line-focusing element that focuses, in a line, light travelled through a medium;

a line sensor; and

a wavefront aberration estimator, wherein

the line sensor receives the light focused in a line by the line-focusing element to obtain a one-dimensional image of the light,

the wavefront aberration estimator includes an image pre-processing unit and a wavefront aberration parameter estimation unit,

the image pre-processing unit pre-processes the one-dimensional image to generate a pre-processed image, and

the wavefront aberration parameter estimation unit inputs the pre-processed image to a wavefront aberration parameter estimation model trained by machine learning and causes the wavefront aberration parameter estimation model to output a wavefront aberration parameter representing a wavefront aberration due to the medium.

### Clause 2

The wavefront sensor according to Clause 1, wherein the line sensor has a frame rate of 10 kHz or higher.

### Clause 3

The wavefront sensor according to Clause 1 or 2, further comprising:

a two-dimensional focusing element; and

a mask, wherein

the line-focusing element is disposed between the mask and the line sensor on an optical path of the light,

on the optical path of the light, the mask is disposed between the two-dimensional focusing element and the line-focusing element and on a focal plane of the two-dimensional focusing element, and

the mask includes a central light-shielding region, a peripheral light-shielding region, and an annular opening formed between the central light-shielding region and the peripheral light-shielding region.

### Clause 4

The wavefront sensor according to any one of Clauses 1 to 3, wherein

the image pre-processing unit rearranges pixels of the one-dimensional image to generate a two-dimensional image, as the pre-processed image, from the one-dimensional image,

the wavefront aberration parameter estimation model includes a convolutional neural network, and

the wavefront aberration parameter estimation unit inputs the two-dimensional image to the wavefront aberration parameter estimation model and causes the wavefront aberration parameter estimation model to output the wavefront aberration parameter.

### Clause 5

The wavefront sensor according to any one of Clauses 1 to 4, wherein the light is emitted from a laser light source or a superluminescent diode.

### Clause 6

The wavefront sensor according to any one of Clauses 1 to 5, further comprising a light-scattering plate, wherein

the light-scattering plate is disposed between the line-focusing element and the line sensor.

### Clause 7

An adaptive optics apparatus, comprising:

the wavefront sensor according to any one of Clauses 1 to 6;

a spatial light modulator; and

a controller that can control the spatial light modulator, the controller being communicatively connected to the spatial light modulator and the wavefront sensor, wherein

the controller receives, from the wavefront sensor, the wavefront aberration parameter representing the wavefront aberration due to the medium and causes the spatial light modulator to form a two-dimensional phase distribution, and

a compensating wavefront aberration due to the two-dimensional phase distribution cancels the wavefront aberration due to the medium.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A wavefront sensor, comprising:
a line-focusing element that focuses, in a line, light travelled through a medium;
a line sensor; and
a wavefront aberration estimator, wherein
the line sensor receives the light focused in a line by the line-focusing element to obtain a one-dimensional image of the light,
the wavefront aberration estimator includes an image pre-processing unit and a wavefront aberration parameter estimation unit,
the image pre-processing unit pre-processes the one-dimensional image to generate a pre-processed image, and
the wavefront aberration parameter estimation unit inputs the pre-processed image to a wavefront aberration parameter estimation model trained by machine learning and causes the wavefront aberration parameter estimation model to output a wavefront aberration parameter representing a wavefront aberration due to the medium.

2. The wavefront sensor according to claim 1, wherein
the line sensor has a frame rate of 10 kHz or higher.

3. The wavefront sensor according to claim 1, further comprising:
a two-dimensional focusing element; and
a mask, wherein
the line-focusing element is disposed between the mask and the line sensor on an optical path of the light,
on the optical path of the light, the mask is disposed between the two-dimensional focusing element and the line-focusing element and on a focal plane of the two-dimensional focusing element, and
the mask includes a central light-shielding region, a peripheral light-shielding region, and an annular opening formed between the central light-shielding region and the peripheral light-shielding region.

4. The wavefront sensor according to claim 1, wherein
the image pre-processing unit rearranges pixels of the one-dimensional image to generate a two-dimensional image, as the pre-processed image, from the one-dimensional image,
the wavefront aberration parameter estimation model includes a convolutional neural network, and
the wavefront aberration parameter estimation unit inputs the two-dimensional image to the wavefront aberration parameter estimation model and causes the wavefront aberration parameter estimation model to output the wavefront aberration parameter.

5. The wavefront sensor according to claim 1, wherein
the light is emitted from a laser light source or a superluminescent diode.

6. The wavefront sensor according to claim 1, further comprising a light-scattering plate, wherein
the light-scattering plate is disposed between the line-focusing element and the line sensor.

7. An adaptive optics apparatus, comprising:
the wavefront sensor according to claim 1;
a spatial light modulator; and
a controller that can control the spatial light modulator, the controller being communicatively connected to the spatial light modulator and the wavefront sensor, wherein
the controller receives, from the wavefront sensor, the wavefront aberration parameter representing the wavefront aberration due to the medium and causes the spatial light modulator to form a two-dimensional phase distribution, and
a compensating wavefront aberration due to the two-dimensional phase distribution cancels the wavefront aberration due to the medium.
